(19) United States
(12) Patent Application Publication
(10) Pub. No.: US 2011/0125858 A1
(43) Pub. Date: May 26, 2011

(54) SYSTEM, A METHOD FOR CONTROLLING A DEVICE AND A PROGRAM THEREOF

(75) Inventor: Kiyoshi YAMABANA, Tokyo (JP)

(73) Assignee: NEC CORPORATION, Tokyo (JP)

(21) Appl. No.: 12/950,010

(22) Filed: Nov. 19, 2010

(30) Foreign Application Priority Data
Nov. 24, 2009 (JP) 2009-266324

(51) Int. Cl. G06F 15/16

(52) U.S. Cl. 709/206

(57) ABSTRACT

A system and method for correcting management information while unerringly reflecting a user's intent by a correction email from the user to the system. The correction processing of the management information is performed according to an extraction result of a difference between the latest management information and the correction email from the user.

This application is based upon and claims the benefit of priority from Japanese patent application No. 2009-266324, filed on Nov. 24, 2009, the disclosure of which is incorporated herein in its entirety by reference.

### BACKGROUND

The present invention relates to a system, a method for controlling a system and a program thereof. More particularly, it rerates to a system, a method for controlling a system and a program thereof capable of referring to, registering, and correcting of management information, such as schedule and reservation of a meeting room, by transmission and reception of emails.

It is known Schedule management devices capable of referring to and correcting a schedule by transmission and reception of emails. Japanese Unexamined Patent Publication No. 2003-058514 (Patent Document 1) and Japanese Unexamined Patent Publication No. 2006-113956 (Patent Document 2) disclose examples of such conventional schedule management devices.

As shown in FIG. 22, a schedule management device of Patent Document 1 is configured containing an email analysis unit 9 and a schedule management unit 11. The email analysis unit 9 analyzes whether a received email is an email of a predetermined schedule format. The schedule management unit 11 compares a schedule described in the email of the predetermined schedule format and an already registered schedule, and performs registration in a schedule registration unit 12. The schedule management unit 11 refuses the registration if a time and a date of the schedule described in the email coincide with those of the already registered schedule. On the other hand, if the date and the time do not coincide with those, it performs the registration.

Moreover, a schedule management device of Patent Document 2 performs a morphological analysis of a new email in response to storing the new email in an email information file, and extracts schedule related words. Then, when the schedule word necessary for creation of the schedule is not clear, the schedule management device of Patent Document 2 extracts a quotation source email from the email information file and extracts an expression corresponding to the undetermined schedule word from the extracted email, in order to convert this undetermined schedule word to an absolute expression.

However, for example, the schedule management device of Patent Document 1 refuses the registration when the time and the date coincide with one another between the schedule described in the email and the already registered schedule. As result, it cannot perform a partial correction such that only a site where the schedule is carried out is altered with respect to the already registered schedule. That is, the conventional schedule management device is not capable of performing the correction that unerringly reflects a user's intention.

Moreover, the schedule management device of Patent Document 1 fixes the correction of the schedule by a user confirming the correction of the schedule later. However, the user must conduct operations of perusal and confirmation of the schedule in addition to transmission/reception of the email, which therefore puts a load on the user. Consequently, there is a problem that the operations cannot to be simple.

On the other hand, the schedule management device of Patent Document 2 is one that extracts a quotation source email of the email, when the schedule management device receives an email requiring alteration and deletion of the schedule and the schedule word necessary for the creation of the schedule is not clear. However, it is not one that unerringly and simply makes the correction of the schedule by transmission/reception of emails.

The present invention is made in consideration of the above point, and provides a system, a method for controlling a system and a program thereof that markedly improves user's usability.

### SUMMARY OF THE INVENTION

Anon-limiting feature of the invention provides a notice email with management information transmitted to a user terminal. A correction email that describes correction management information to the management information described in the transmitted notice email is received at a receiver. An email search unit searches the transmitted notice email corresponding to the correction email. A difference extraction unit configured to extract a difference between the correction management information described in the correction email and the management information described in the transmitted notice email. A correction unit corrects the corresponding management information of the management unit according to the difference extraction result of the difference extraction unit.

According to another feature of the invention there is provided a method for carrying out the correction of information using difference information between transmitted management information and correction management information received from a user.

### BRIEF DESCRIPTION OF THE DRAWING

The above and other aspects of the present invention will become more apparent by describing in detail exemplary embodiment thereof with reference to the attached drawings in which:

FIG. 1 is a block diagram showing a functional configuration of a schedule management device in a first exemplary embodiment of the invention.

FIG. 2 is a diagram showing a hardware configuration of the schedule management device.

FIG. 3 is a flowchart showing an operation of the schedule management device.

FIG. 4 is a flowchart showing an operation of the schedule management device.

FIG. 5 is a diagram showing one example of a content of the schedule management unit.

FIG. 6 is a diagram showing one example of a schedule notice email.

FIG. 7 is a diagram showing one example of a correction instruction email by a user.

FIG. 8 is a diagram showing one example of an output of a difference extraction unit.

FIG. 9 is a diagram showing one example of a content of the schedule management unit.

FIG. 10 is a diagram showing one example of a correction instruction email by the user.

FIG. 11 is a diagram showing one example of an output of the difference extraction unit.

FIG. 12 is a diagram showing one example of a content of the schedule management unit.

FIG. 13 is a diagram showing one example of a content of the schedule management unit updated by the conventional technology.

FIG. 14 is a diagram showing one example of a correction instruction email by the user.

FIG. 15 is a diagram showing one example of a correction instruction email by the user.

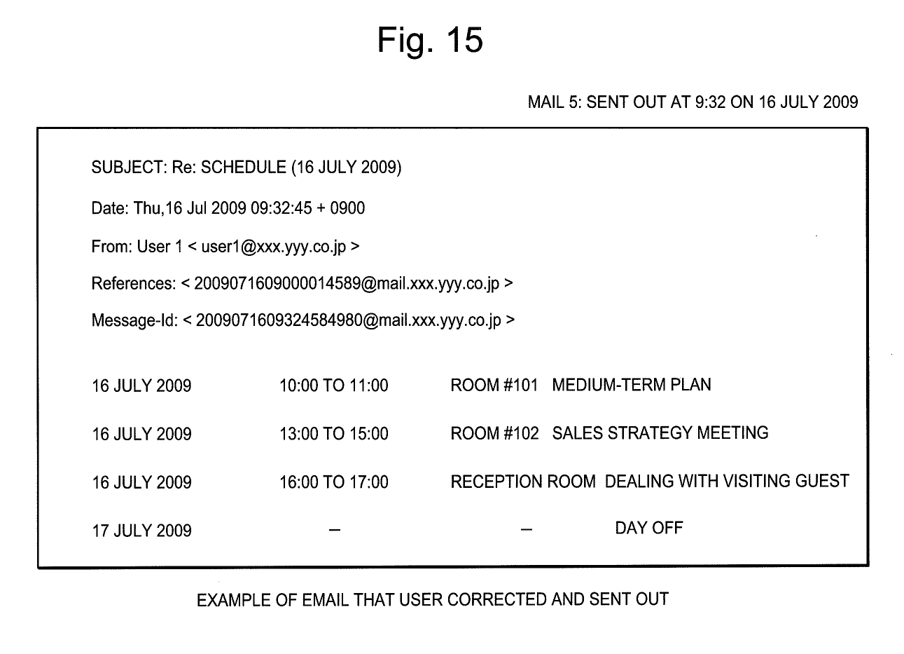

FIG. 16 is a diagram showing one example of an output of the difference extraction unit.

FIG. 17 is a diagram showing one example of an output of the difference extraction unit.

FIG. 18 is a diagram showing one example of a content of the schedule management unit.

FIG. 19 is one example of an email notifying the user that the content of the correction instruction email and the master schedule is not consistent with each other.

FIG. 20 is a diagram showing one example of a content of the schedule management unit.

FIG. 21 is a diagram showing one example of a content of the schedule management unit in the case of applying the present invention to a meeting room reservation system.

FIG. 22 is a diagram showing a configuration of the schedule management device by the conventional technology.

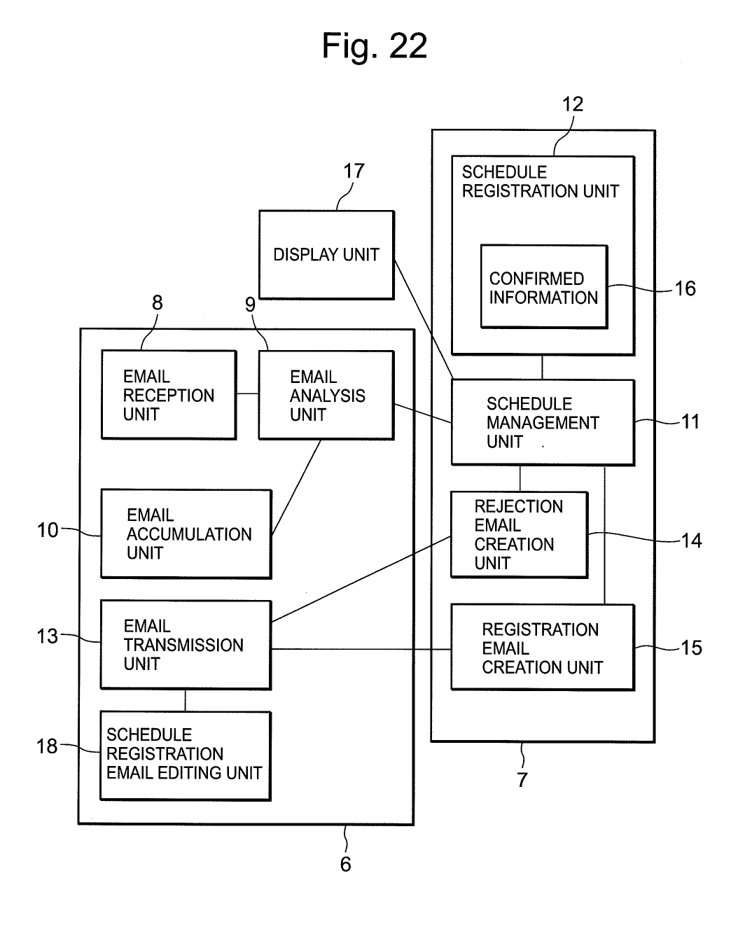

### DETAILED DESCRIPTION

A first exemplary embodiment of the present invention will be explained in detail with reference to drawings.

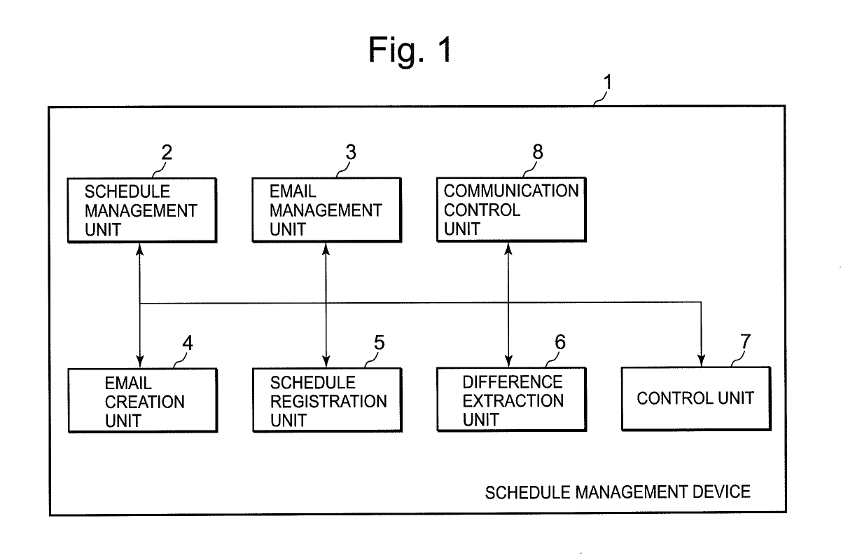

FIG. 1 shows a functional configuration of a schedule management device 1 of this embodiment. Referring to FIG. 1, the schedule management device 1 of this embodiment is configured having: a management unit such as a schedule management unit 2, an email unit such as both an email management unit 3 and an email creation unit 4, an transmitter and receiver unit such as a communication control unit 8, an email search unit such as a control unit 7, a difference extraction unit 6 and a correction unit such as a schedule registration unit 5.

The schedule management unit 2 stores and manages a master schedule. The email management unit 3 stores and manages sent emails and received emails related to the master schedule. The email creation unit 4 creates a schedule notice email based on the master schedule stored in the schedule management unit 2. The schedule registration unit 5 registers and corrects the master schedule to the schedule management unit 2. The difference extraction unit 6 calculates a difference of schedule information described in the schedule notice emails. The control unit 7 comprehensively controls the whole of the schedule management device 1. The communication control unit 8 controls transmission and reception of emails to/from the outside

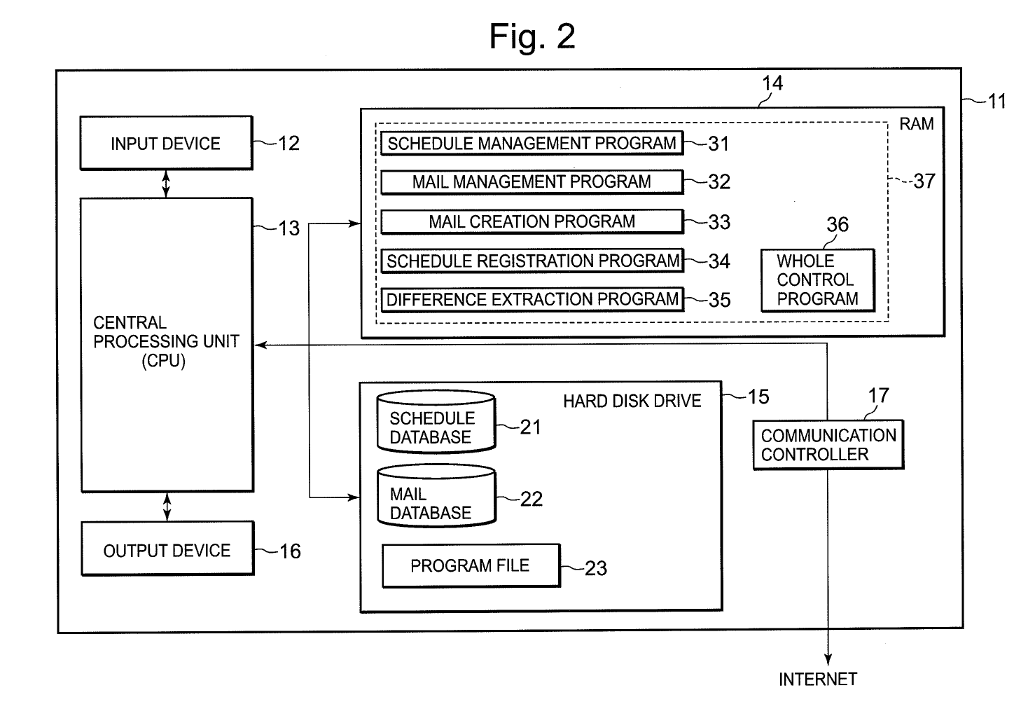

FIG. 2 shows a hardware configuration of the schedule management device 1 of this embodiment. Referring to FIG. 2, the schedule management device 1 is configured having an input device 12, a central processing unit (CPU) 13 for operating by a program control, random access memory (RAM) 14, a hard disk drive 15, an output device 16, and a communication controller 17.

The hard disk drive 15 stores the schedule information. It has a schedule database 211, an email database 22 for storing emails that were transmitted and received, and a program file 23. The program file 23 is read into the random access memory 14, and controls an operation of the central processing unit 13. The input device 12 is an input device, such as a keyboard, and the output device 16 is an output device, such as a display terminal. The communication controller 17 is a network adapter, such as a cable LAN adapter and a wireless LAN adapter, and has a function for communicating via a LAN/WAN.

A schedule management program 37 has a schedule management program 31, an email management program 32, an email creation program 33, a schedule registration program 34, a difference extraction program 35, and a whole control program 36. The central processing unit 13 is configured to control respective subprograms of the schedule management program 31, the email management program 32, the email creation program 33, the schedule registration program 34, and the difference extraction program 35 to operate by executing the whole control program 36.

The schedule management program 31 stores and manages the schedule information by controlling the schedule database 21 on the hard disk drive 15. The email management program 32 controls the email database 42, and stores and manages the emails. The email creation program 33 creates and transmits an email that describes the schedule information. The difference extraction program 35 extracts a difference of pieces of the schedule information described in the emails. The schedule registration program 34 refers to a difference bulletin of the schedule that the difference extraction program 35 outputs, and updates the schedule information stored in the schedule database 41 so that the schedule information may become consistent with this. Incidentally, the schedule management program 31, the email management program 32, the email creation program 33, the schedule registration program 34, and the difference extraction program 35 are executed by the central processing unit 13.

The schedule management program 31 is a computer program that makes the central processing unit 13 perform a processing corresponding to the schedule management unit 2. The email management program 32 is a computer program that makes the central processing unit 13 perform a processing corresponding to the email management unit 3. The email creation program 33 is a computer program that makes the central processing unit 13 perform a processing corresponding to the email creation unit 4. The schedule registration program 34 is a computer program that makes the central processing unit 13 perform a processing corresponding to the schedule registration unit 5. The difference extraction program 35 is a computer program that makes the central processing unit 13 perform a processing corresponding to the difference extraction unit 6. The whole control program 36 is a computer program that makes the central processing unit 13 perform a processing corresponding to the control unit 7.

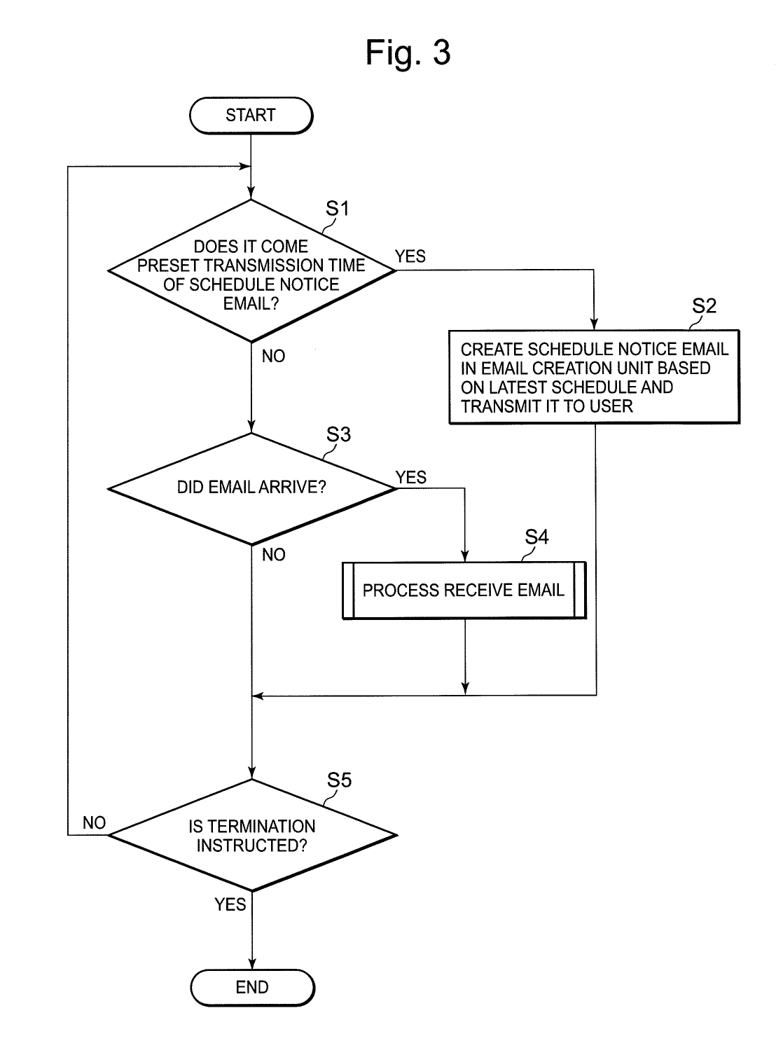

Next, an operation of the schedule management device 1 of this embodiment will be explained with reference to a flowchart of FIG. 3.

The schedule management device 1 of this embodiment has a function of transmitting to a user (a user's information processor etc.) a content of the registered master schedule every day at an appointed time as an email. Moreover, the schedule management device 1 of this embodiment has a function that, when receiving an email instructing correction of the master schedule from the user (the user's information processor etc.), corrects the master schedule stored in the schedule management unit 2 according to the content of the email.

In order to realize these functions, upon being activated, the control unit 7 of the schedule management device 1 determines whether the current time has become a transmission time of the schedule notice email specified in advance (Step S1).

When it has become the transmission time (Step S1: YES), the control unit 7 of the schedule management device 1 creates the schedule notice email based on the latest master schedule stored in the schedule management unit 2 by the email creation unit 4, and transmits it to the user (Step S2). After transmission completes, the control unit 7 of the schedule management device 1 stores that schedule notice email in the email management unit 3, and the process returns to Step S1 again. On the other hand, when it has not become the transmission time (Step S1: NO), the control unit 7 of the schedule management device 1 checks whether the email related to a schedule correction arrived by the communication control unit 8 (Step S3).

When the email arrived (Step S3: YES), the control unit 7 of the schedule management device 1 processes the received email by the email management unit 3 (Step S4). At this Step S4, a schedule correction processing according to the content of the receive email is performed. Details of the processing will be described later. On the other hand, when the email did not arrive (Step S4: NO), the control unit 7 of schedule management device determines whether termination, such as power off (OFF) of the whole device, was instructed (Step S5).

If the termination was not instructed (Step S5: NO), the control unit 7 of the schedule management device 1 makes the process return to Step S1 again. That is, the control unit 7 of the schedule management device 1 repeats a loop of waiting two events, Step S2 and Step S4, until the termination is instructed. On the other hand, if the termination was instructed (Step S5: YES), the control unit 7 of the schedule management device 1 terminates the operation.

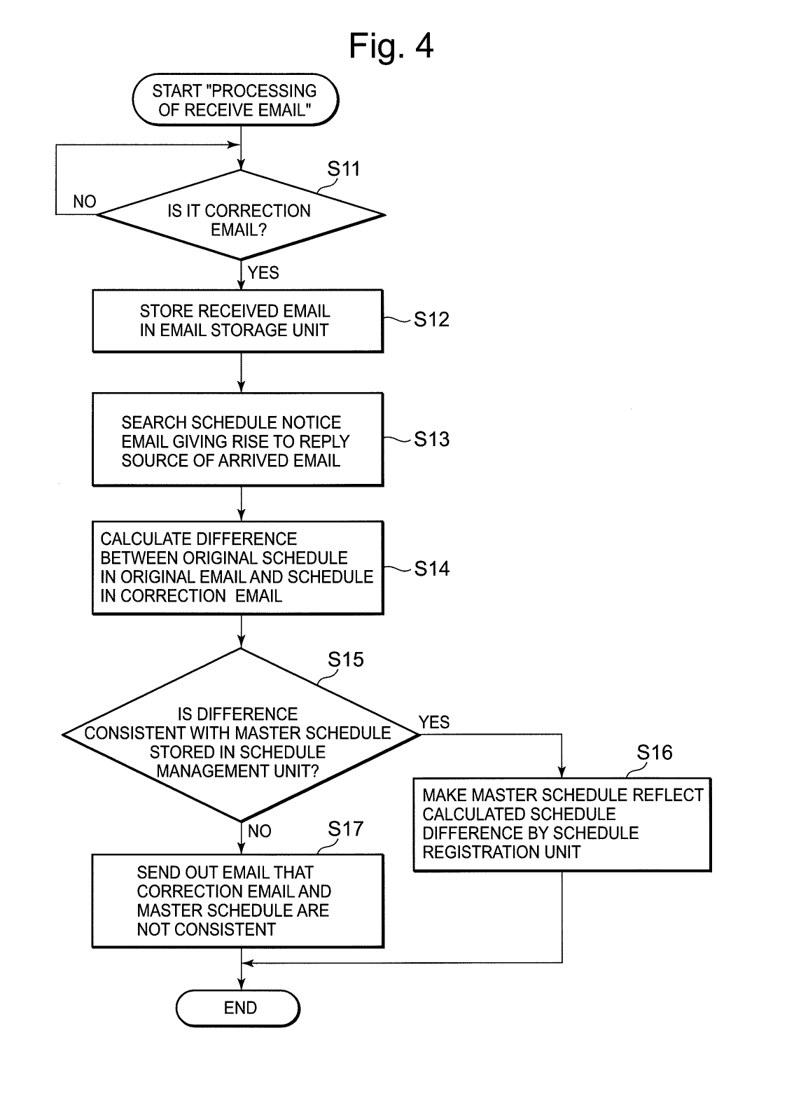

Next, details of a processing of received emails (Step S4) will be explained with reference to a flowchart of FIG. 4.

First, the control unit 7 of the schedule management device 1 checks whether the received email is the correction email (a reply email to the schedule notice email or an email based on a transfer email that quotes the reply email (this will be described later) (Step S11). Then, if the received email is the correction email (Step S11: YES), the control unit 7 of the schedule management device 1 stores the correction email in the email management unit 3 (Step S12). Next, the control unit 7 of the schedule management device 1 searches the schedule notice email that was a reply source of the correction email from among emails stored in the email management unit 3 by the email management unit 3 (Step S13). Usually, since a message ID of the schedule notice email (that will be described later) used as a source when performing a reply and email transmission is recorded in a header of the correction email, the email management unit 3 can search the schedule notice email by using the message ID as a clue.

Next, the control unit 7 of the schedule management device 1 calculates a difference between the schedule information described in the correction email and the schedule information of the schedule notice email that was used as its reply source by the difference extraction unit 6 (Step S14). The difference becomes a content that the user who made the correction email wishes to alter. Next, the control unit 7 of the schedule management device 1 checks whether the difference and the master schedule stored in the schedule management unit 2 are consistent with each other by the schedule registration unit (Step S15).

When they are consistent (Step S15: YES), the control unit 7 of the schedule management device 1 makes the master schedule to which the schedule management unit 2 corresponds reflect the difference of the schedule calculated by the schedule registration unit 5 (the master schedule is corrected) (Step S16), and after that, terminates the “processing of received email.” On the other hand, if they are not consistent (Step S15: NO), the control unit 7 of the schedule management device 1 sends out the user a communication email that correction of the schedule is failed by the schedule registration unit 5 (Step S17), and after that, terminates the “processing of received email.”

Seeing the above operations from a viewpoint of the user, first the user can receive the latest schedule information by email every day at a fixed time. This is a result of the processing of Step S2. Next, if the user refers to the transmitted schedule notice email and wishes to correct the schedule, the user sends a reply email, an email based on transfer, or the like back to the schedule management device 1, with the corrected schedule information.

When the schedule management device 1 receives the reply email, the email based on transfer, or the like, a difference between it and the schedule notice email that was used as a reply source is calculated (Step S14). The difference is a portion that the user wishes to correct. If the difference is consistent with the master schedule stored in the schedule management unit 2, the correction result will be reflected in the master schedule (Step S16). Moreover, if they are not consistent, the inconsistency will be informed by email (Step S17).

That is, in this embodiment, at Step S14, a difference between a description content of the schedule notice email (an original email that the user used at the time of the schedule correction) and a description content of the correction email is extracted. What the user intends to correct is only the portion of the difference. And any portion that is not altered from the description content of the original email other than the difference must not be corrected even if it differs from the latest master schedule of the schedule management unit 2. In this case, it is not necessary to correct the master schedule in the schedule management unit 2.

On the other hand, even if the description content of the correction email after the schedule correction agrees with the latest master schedule stored in the schedule management unit, there is a possibility that the user judged a correction content based on the schedule information that was not the latest if the description content of the schedule notice email is different from the latest master schedule; therefore, it is risky to make the correction content reflect on the master schedule unconditionally. In this case, a more unerring schedule correction can be urged by transmitting the latest schedule to the user and asking the user for reconfirmation or by other ways.

Thus, since the schedule management device 1 judges the necessity for correction by obtaining a difference between the schedule information described in the schedule notice email that the correction email considered as a reference and the corrected schedule information described in the correction email. As a result, it is possible to perform the schedule correction that unerringly catches such correction intention of the user as cannot be judged only by checking the correction email after user correction.

Incidentally, there are various methods for calculation of the difference in this embodiment. For example, it can be comparison by a diff command of UNIX (registered trademark) on a line-to-line basis. Generally, whatever kind of algorithm may be adopted as long as it is a calculation method capable of obtaining a difference with a line as a unit.

Moreover, in this embodiment, the user can perform reference and the correction of the schedule simply on an email basis. Especially, since the difference extraction unit 6 unerringly understands the user's correction intention and makes it reflected in the master schedule, the schedule correction can be carried out unerringly with the user' intention reflected correctly despite a simple interface on the email basis.

Next, an operation of this embodiment will be explained in detail using a concrete example. In this example, it is set that the schedule management device 1 sends out the schedule notice email every day at 3:00 a.m.

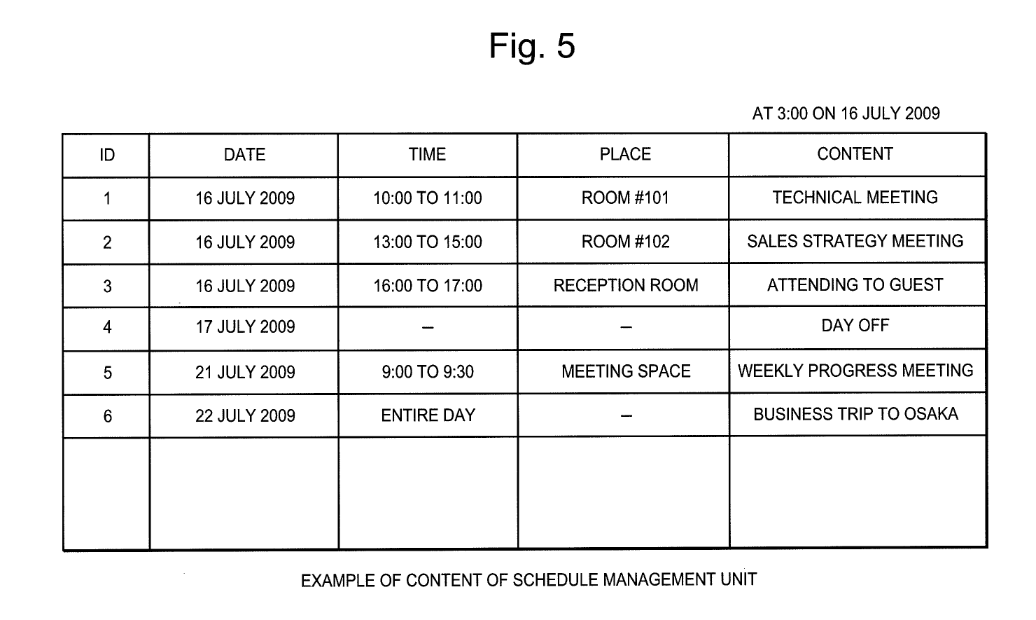

FIG. 5 is a diagram showing an example of the latest master schedule stored in the schedule management unit 2 for a certain user. The contents of this master schedule are, for example, ones that are stored in the schedule management unit 2 exactly at 3:00 a.m. on 16 Jul. 2009, in which six master schedules are registered. Specifically, there are registered: three schedules such attending meetings and dealing with a visitor on 16 Jul. 2009 (ID1 to ID3); one day-off schedule on 17 Jul. 2009 (ID4) ; one meeting on 21 Jul. 2009 (ID5); and one business trip on 22 Jul. 2009 (ID6).

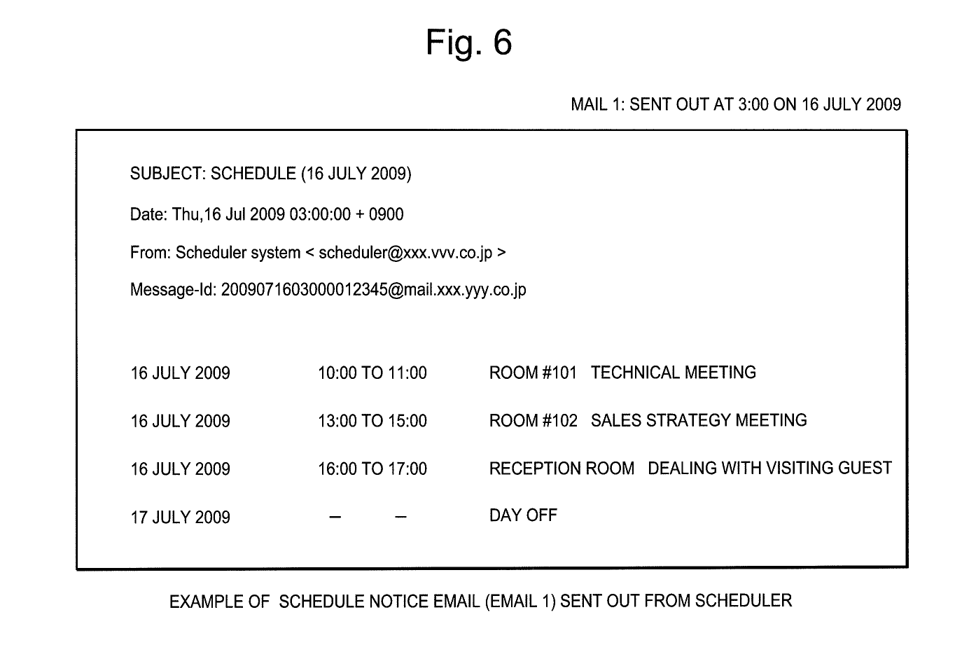

FIG. 6 is a diagram showing the schedule notice email that was created by the email creation unit 4 of the schedule management device 1 based on the content of the schedule of FIG. 5 at 3:00 a.m. on 16 Jul. 2009 and was sent out from the communication control unit 8. Each schedule is written in the schedule notice email being in the form of one line for one item, as a text character string in accordance of a fixed type format. In this example, date, time, place, and content constitute a character string of one line with each separated with a tab character, which is entered in the text of the schedule notice email.

Moreover, three-day-after schedules including that day of transmission are described in the schedule notice email: specifically, four schedules up to the day off schedule on 17 July are entered in an email text in four lines. Moreover, a character string containing a sending date is automatically generated and is inserted into a subject (Subject). The message ID is information for identifying the email globally and uniquely: The message ID is a unique number which is automatically given to every email by using information such as the sending date, a sending time, a sender, a send domain and a random number by the mailer (hereinafter this email is called an email 1).

### (1) Example 1

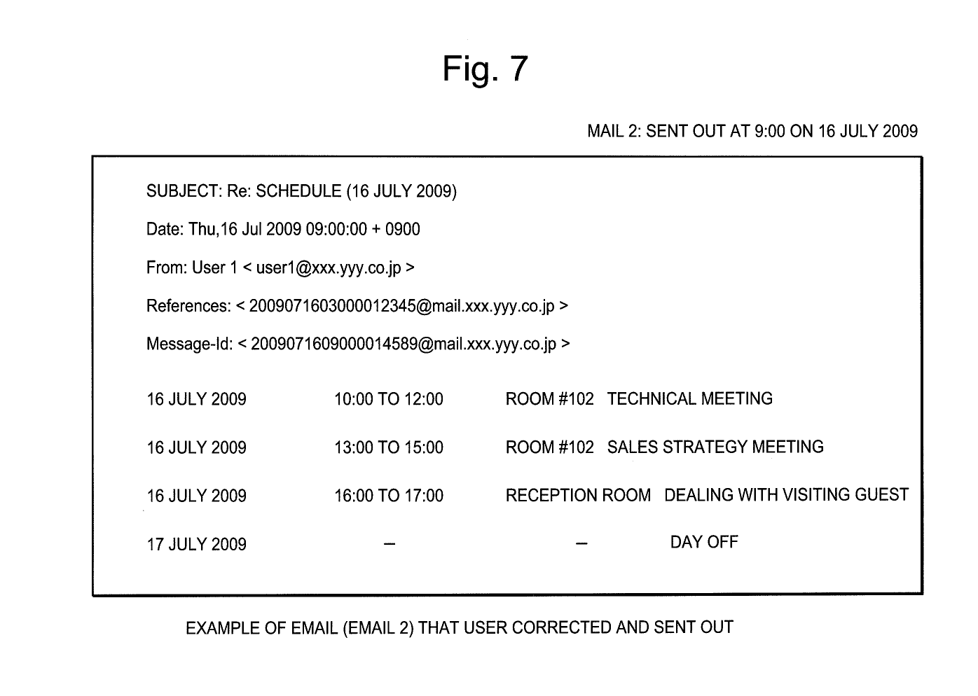

FIG. 7 is a diagram showing a content of the email (hereinafter referred to as an email 2) that was sent back to the schedule management device 1 at 9:00 in the morning on the same day (16 Jul. 2009) by the user who received the email 1 of FIG. 6 intending to correct a part of the schedule. A user 1 has corrected a schedule on the first line of the schedule (a technical meeting is held in Room #101 from 10:00 to 11:00 on 17 July) to a schedule that a technical meeting is held in Room #102 from 10:00 to 12:00 on the same day (17 July). Other schedules described from the second line to the fourth line in the email 2 are not intended to be altered by the user, remaining as they were in the initial state.

A message ID of the email 1 is described in the references of the email header of the email 2, indicating that the email 1 gives rise to a reply source of the email 2. When the user creates an email based on a reply function, a transfer function, etc. of the mailer, normally such a description of references is automatically given by the mailer.

The control unit 7 of the schedule management device 1 will start the “processing of received email” of Step S4 upon reception of the email 2. First, the control unit 7 of the schedule management device 1 checks whether the received email is the correction email at Step S11, and stores the received email 2 in the email management unit 3 at Step S12. Next, the control unit 7 of the schedule management device 1 searches a schedule notice email giving rise to the reply source of the email 2 by the email management unit 3 at Step S13. Since, in the email 2, 2009071603000012345@mail.xxx.yyy.co.jp that is a message ID of the reply source email is stored in its header, the control unit 7 of the schedule management device 1 can find the email 1 that is pertinent by searching the email management unit 3 using the message ID as a clue.

Here, the email is stored in the email management unit 3 with the message ID included in the index so that the email can be searched by using the message ID as a key to the index. However, if the email can be searched by using the message ID as a key, a concrete storage method is not limited to this embodiment. For example, it may be all right to perform the storage method in such a way that all the emails are simply stored in plain text (Plain text), and when performing a search using the message ID as a key, all the emails are put in full text search with a character string of the message ID.

Next, the control unit 7 of the schedule management device 1 extracts a difference between the schedule information described in the text of the email 1 and the schedule information described in the text of the email 2 by the difference extraction unit 6 at Step S13.

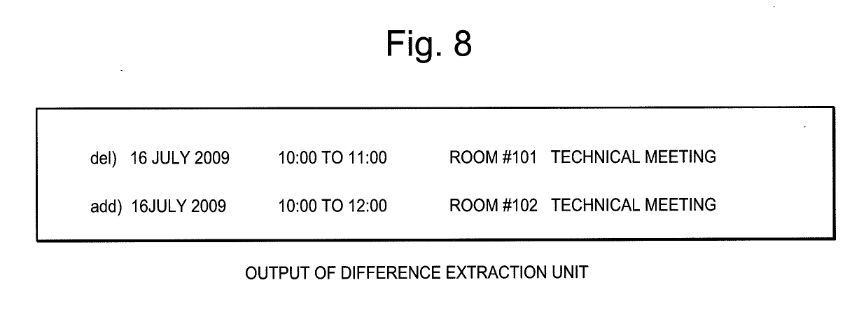

FIG. 8 shows a difference extraction result of the email 1 and the email 2. What exists in a line designated by “del)” in its head is an old schedule described in the email 1 (a technical meeting is held in Room #101 from 10:00 to 11:00). On the other hand, what exists in a line designated by “add)” in the head is a new schedule described in the email 2 after the correction by the user 1.

Next, the control unit 7 of the schedule management device 1 updates the master schedule of the schedule management unit 2 by the schedule registration unit 5 based on this difference extraction result. What the schedule registration unit 5 considers as a processing object is only this difference extraction result. And a schedule that is described in a text of the email 2 but that is not described in the difference extraction result does not become an object that is reflected in the master schedule stored in the schedule management unit 2. In other words, any portion that was not altered when the user created the email 2 is not reflected as a correction point to the master schedule by the schedule registration unit 5. Thus, a user 2's correction intention can be unerringly determined by the difference extraction processing done by the difference extraction unit 6.

Next, the control unit 7 of the schedule management device 1 checks whether the extracted difference extraction result and the master schedule are consistent with each other by the schedule registration unit 5 (Step S15). Specifically, the control unit 7 of the schedule management device 1 checks whether there exits a line whose content coincides with that of the line described as (del) in the master schedule.

If it does not exist (Step S15: NO), the control unit 7 of the schedule management device 1 recognizes that the user tried to alter it by referring to the master schedule that was already deleted, and determines that a difference extraction result and the master schedule are not consistent with each other. On the other hand, if it exists (Step S14: YES), the control unit 7 of the schedule management device 1 recognizes that the user tried to make an alteration to the master schedule and corrected it, and determines that the difference extraction result and the master schedule are consistent with each other.

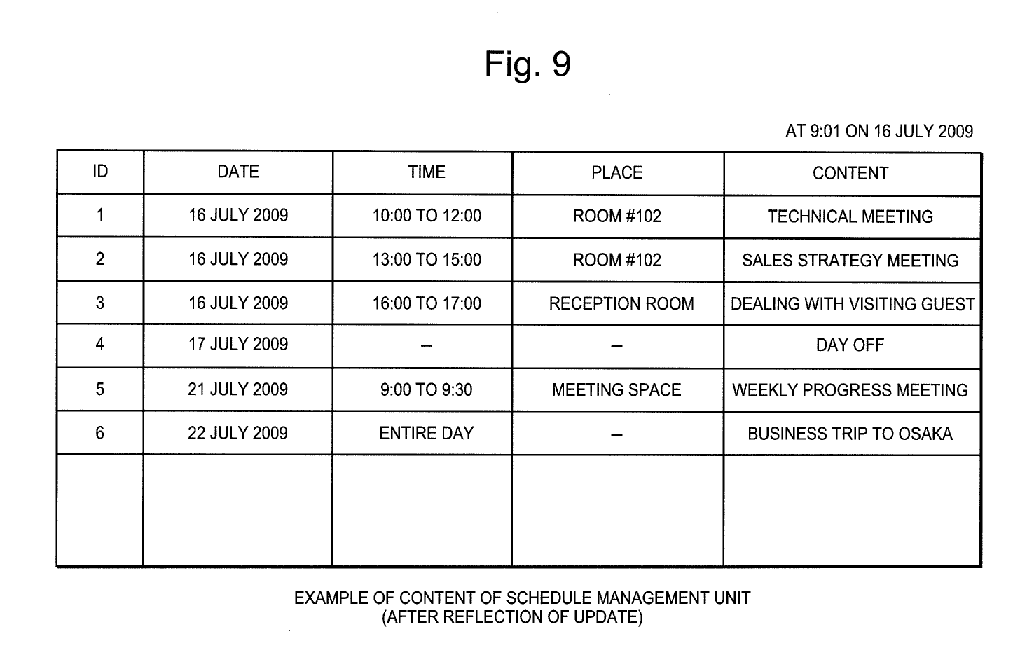

Since in Example 1, the content of the master schedule at the time of Step S15 is as described in FIG. 5. And the same line as described as del) in FIG. 8 exists in the schedule ID1. As a result, it is determined that they are consistent with each other and update of the master schedule is performed at Step S16. Specifically, in this example, the control unit 7 of the schedule management device 1 deletes the line of del) of FIG. 8 and adds a line of add) to the master schedule by the schedule registration unit 5. As a result, immediately after the transmission of the email 2 (after 9:00 on 16 July), the master schedule on the schedule management device 1 is corrected reflecting the email 2 to be altered to a content shown in FIG. 9. Thereby, the master schedule will be consistent with the content that the user 2 assumes at the timing of creating the email 2, and consequently the correction content will become one that unerringly reflects a user's intention.

### (2) Example 2

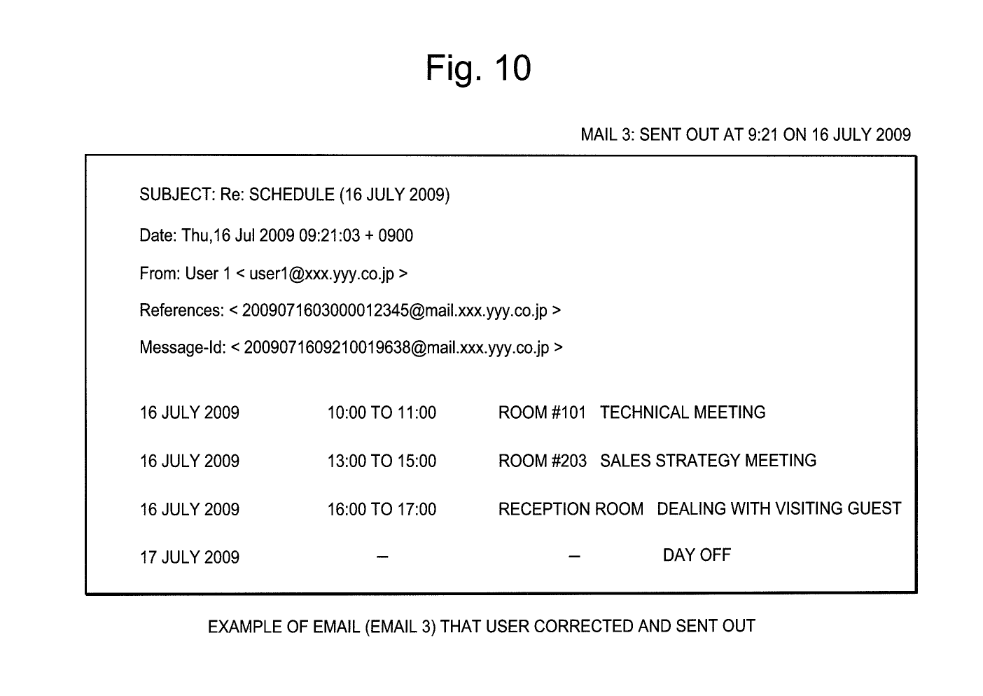

Next, in the situation of exemplary embodiment 1, another user (the user 2) sends an email (an email 3) shown in FIG. 10 to the schedule management device 1. The user 2 intends to change the place of sales strategy meeting being set 13:00 through 15:00 from Room #102 to Room #203.

The user 2 creates the email 3 of FIG. 10 by correcting only the pertinent portion (schedule from 13:00 to 15:00) using the reply function, the transfer function, or the like of the mailer. And the user 2 sends it back to the schedule management device 1.

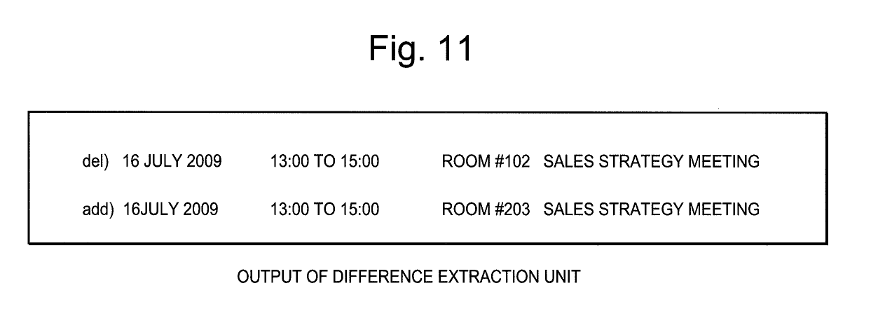

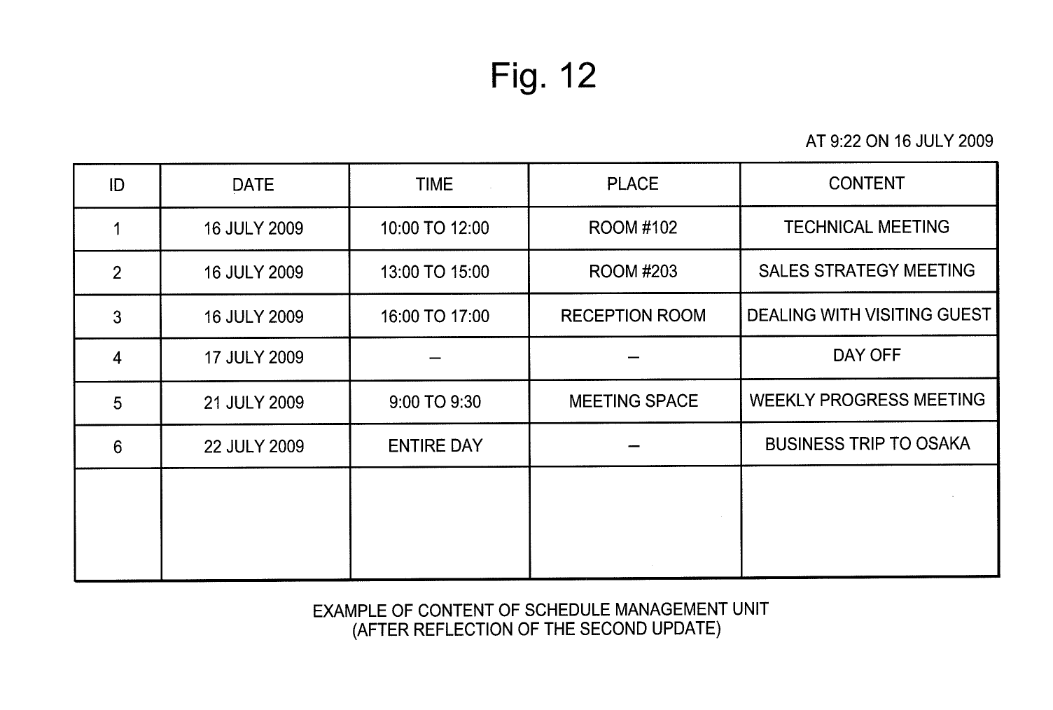

FIG. 11 is a difference extraction result between the email 1 giving rise to a reply source of the email 3 and the email 3 transmitted by the user 2. In Example 2, the content of the master schedule at the time of Step S15 is like description of FIG. 9 and is determined to be in consistent because the same line as described as del) in FIG. 11 exists in the schedule ID2. Therefore, the master schedule is updated at Step S16 and a state shown in FIG. 12 is obtained as a result.

Here, since the update by the email 2 is one that is related to only ID1 (technical meeting) of the schedule and the update by the email 3 is one that is related to only ID2 (sales strategy meeting) of the schedule. Therefore, a difference calculated based on the email 2 and a difference calculated based on the email 3 are independent of each other. Therefore, since the schedule management device 1 can obtain a like state of FIG. 12 by applying two difference extraction results to a state of FIG. 5 in whichever order, it can perform schedule updates of both the schedule correction by the email 2 and the schedule correction by the email 3 without inconsistency.

On the other hand, in Patent Document 1, the master schedule of the schedule management unit 2 will not be corrected when the schedule management unit 2 sends the email 3 in a state shown in FIG. 9, because different schedules are put in the same time zone. In this case, although it is possible for the user to make a direct access to the schedule management device 1 separately and to perform the schedule correction by an operation through a GUI (Graphical User Interface), simple correction on the email basis will not be able to be performed.

Next, with respect to this email 3 as an example, a principle that the schedule correction reflecting to user's intention can be performed by obtaining a difference between the email after the correction and the email giving rise to the reply source is described in detail. For example, the email 3 has a schedule indicating that a technical meeting is held in Room #101 from 10:00 to 11:00.

On the other hand, at a time when applying the schedule correction by the email 3, a content different from this (a new schedule corrected by the email 2) is stored in the master schedule of the schedule management unit 2, as shown in FIG. 9. Both a description of the first line “16 Jul. 2009 from 10:00 to 11:00 Room #101 Technical meeting” of the text of the email 3 and a description of the second line “16 Jul. 2009 from 13:00 to 15:00 Room #203 Sales strategy meeting” are different contents from those of the master schedule of the schedule management unit 2.

However, it cannot be determined only from the content of the email 3 whether this is a correction request to the current master schedule or is a part of the schedule that was referred to at the time of correction and is remaining as it is.

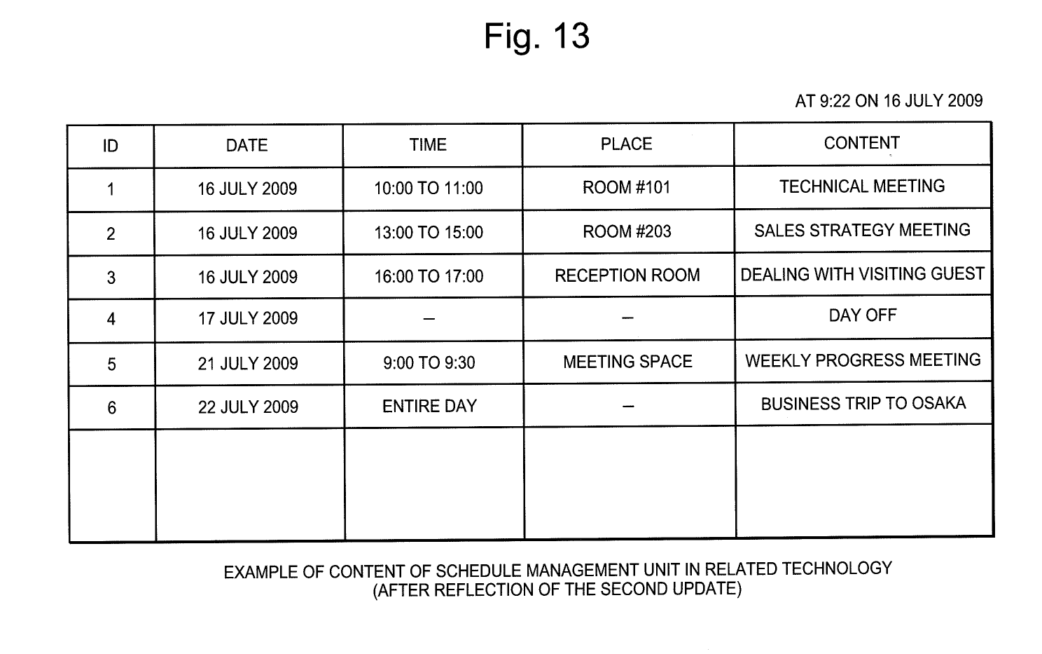

In this case, even if the content of the email 3 is compared with the master schedule, it is difficult to rightly determine that the first line of the text of the email 3 must not be reflected in the master schedule, but only the second line must be reflected. If both the first line and the second line of the email 3 are made to be reflected in the master schedule as corrections thereto, the schedule of the technical meeting that the user 1 corrected with the email 2 will return to a state before the correction against the user's intention, as shown in FIG. 13. On the other hand, unless both are reflected in the master schedule, the correction of the second line that the user 2 intended will not be reflected in the master schedule. Thus, it is difficult to judge the user's correction intention unerringly in such a case.

The control unit 7 of the schedule management device 1 of this embodiment can unerringly judge the user's intention, for example: what the user intends to correct is only “16 Jul. 2009 13:00 to 15:00 Room #203 Sales strategy meeting” in the second line in which a difference occurs among the description contents of the email 3; and since a difference does not occur in “16 Jul. 2009 10:00 to 11:00 Room #101 Technical meeting,” the user does not intend the correction, by obtaining a difference between the description contents of the email giving rise to the reply source and description contents of the reply email after the correction by the difference extraction unit 6.

In this way, the control unit 7 of the schedule management device 1, reflecting the user's intention rightly, can take in only the content of the second line as the correction of the master schedule in the schedule management unit 2. That is, even if ID1 of the schedule that was not altered by the user has a content different from the master schedule at the time of the application, the schedule management device 1 of this embodiment can determine unerringly that it is not necessary to update the master schedule by making this reflect therein by obtaining a difference of these two emails using information that the email 3 is created on a base of the email 1.

In this way, according to this embodiment, the user's correction intention can be judged unerringly by obtaining a difference between the description content of the schedule notice email giving rise to the reply source and the description content of the correction email after the correction by the difference extraction unit 6. Therefore, it is possible to unerringly perform the correction of the schedule even on the email basis. Since the user can correct the master schedule of the schedule management device 1 by quoting the schedule notice email and sending the correction email after editing only the correction points without accessing to the schedule management device 1, it is possible for the user to easily perform the schedule correction.

Incidentally, there is no possibility that either del) or add) among differences may not exist, depending on the correction content by the user. When del) does not exist, it means that the user simply adds a schedule without deleting anything from the description of the original email. In this case, since there is not a line of del) that should be subjected to consistency checking, the consistency between the difference extraction result and the master schedule is always secured, and it is simply added to the master schedule. On the other hand, when there is no add), it means that the user performed only deletion from the original email. In this case, after checking consistency between the difference extraction result and the master schedule, a processing of deleting a pertinent master schedule is performed.

### (3) Example 3

A difference of the result caused by a difference of the schedule notice email giving rise to a reply operation, a transfer operation, etc. will be explained specifically below.

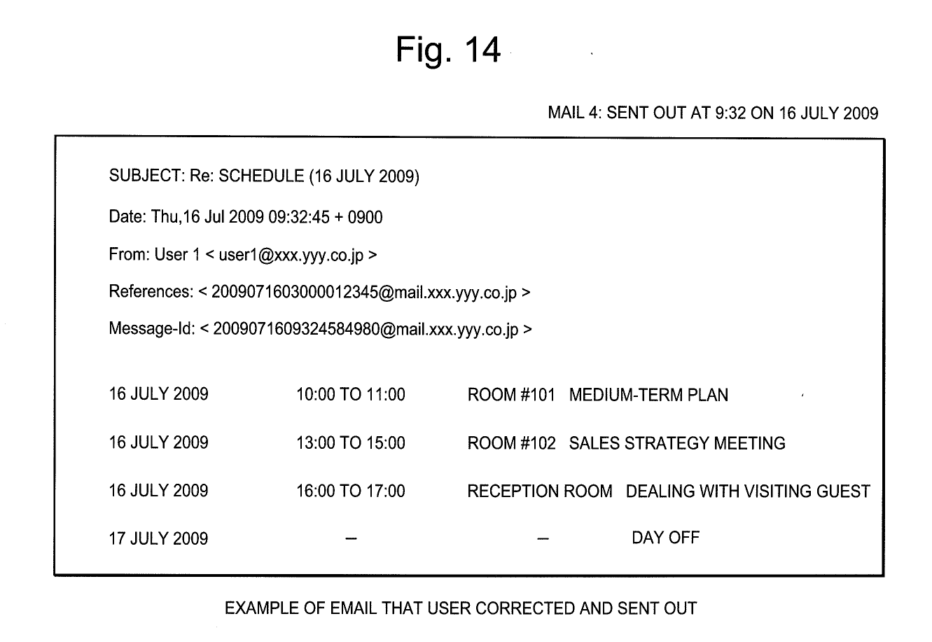

FIG. 14 is an email (hereinafter called an email 4) that was replied after performing a reply operation, a transfer operation, etc. on the email 1. FIG. 14 is an email (hereinafter called an email 5) that was replied after performing a reply operation, a transfer operation, etc. on the email 2. The email 4 and the email 5 have exactly the same content of the letter, and either email is altered only on the schedule ID1 to the original schedule notice email. Transmission from the user was each done at 9:32, and each is one that instructs correction to the master schedule being in a state shown in FIG. 12.

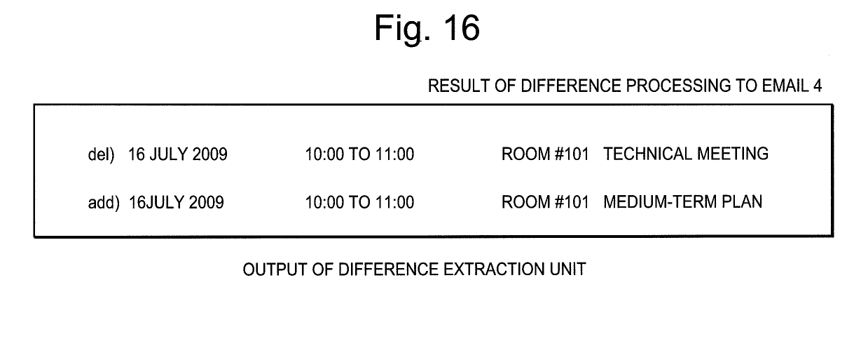

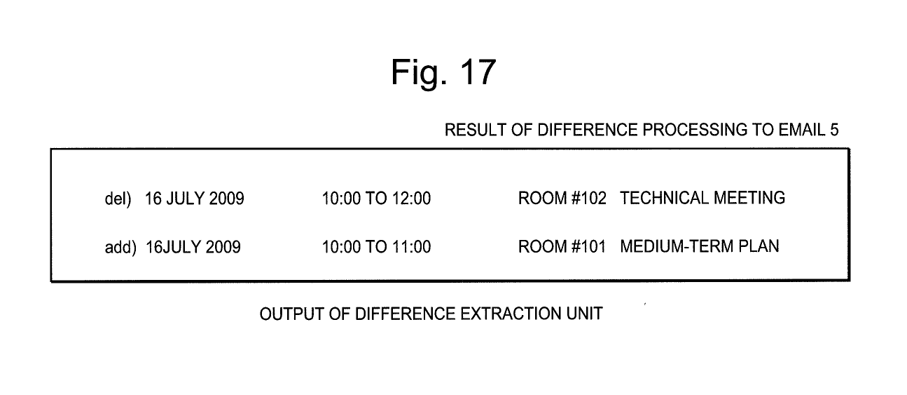

FIG. 16 shows a difference extraction result extracted by the difference extraction unit 6 to the email 4; FIG. 17 shows a difference extraction result extracted by the difference extraction unit 6 to the email 5. Since the schedule notice emails of the reply sources (sources of the reply operation, the transfer operation, etc.) are different between the email 4 and the email 5, the content to be described in del) is different according to that difference.

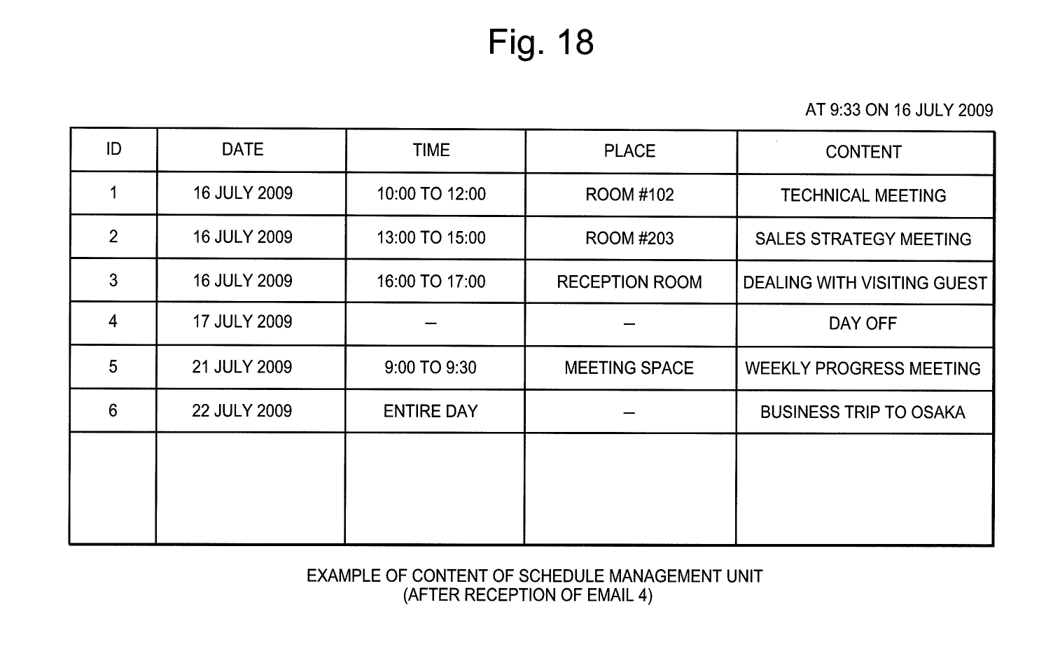

Even if the email 4 is transmitted to the schedule management device 1, when the difference extraction result with the email 1 is intended to be applied to the schedule management unit 2, inconsistency between the master schedule and it is detected. This is because the email 4, the email 1 that is the original email, and the master schedule become inconsistent with one another as a result that the master schedule was updated by the email 2. For this reason, the correction instructed by the email 4 is not applied to the master schedule, and the master schedule of the schedule management unit 2 will be in the state of FIG. 12 as it is, as shown in FIG. 18.

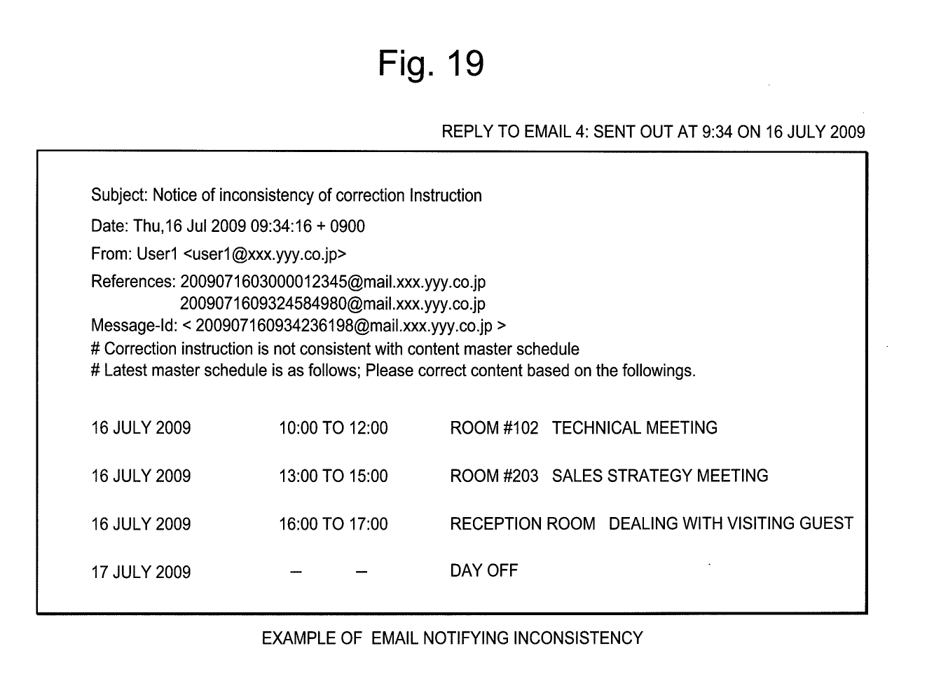

FIG. 19 is an example of the return email that was returned to the user after the email 4 was transmitted. The return email is described that the difference extraction result extracted by the difference extraction unit 6 was not consistent with the latest master schedule in addition to the content of the latest master schedule by the email creation unit 4. The user recognizes that a correction instruction email (here, the email 4) giving rise to the reply source or a transfer source was not reflected in the master schedule by referring to this email, and performs the correction of the master schedule based on the latest master schedule described in the text again and sends the email back to the schedule management device 1. As a result, the user can make an intended correction be reflected in the master schedule. That is, correction that the user intends is reflected in the master schedule by the schedule registration unit 5.

This is a state after ID1 of the schedule shown in FIG. 12 is corrected reflecting the email 2. And this operation correctly reflects a fact that it has been already different from the content described in the email 1.

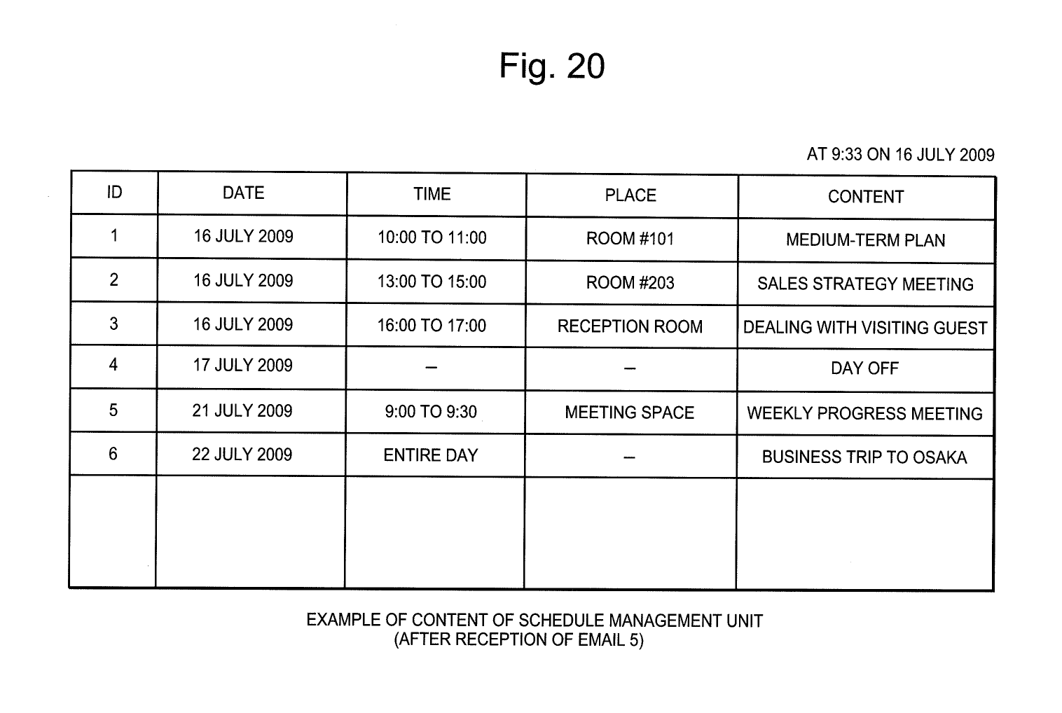

On the other hand, when the user intends to apply a difference extraction result between the email 5 and the email 2 to the schedule management unit 2, consistency between the master schedule and it is detected. Therefore, the email 5 is applied to the master schedule by the schedule registration unit 5, the correction is reflected, and the master schedule is updated to a state shown in FIG. 20.

Thus, in this embodiment, even when the contents of emails each instructing the content of the correction by the user are exactly the same, if the user performs a reply or mail transmission based on transfer after referring to the email (the email 2) that is consistent with the latest master schedule, the correction will be reflected. On the other hand, if the user creates and sends the reply email or the email based on transfer by referring to the email (the email 1) that is not consistent with the latest master schedule and further by correcting an entry that is not consistent, the correction will not be reflected after detecting inconsistency.

That is, in this embodiment, it is possible for the schedule management device 1 to prevent erroneous update of the master schedule that is different from the user's intention. Because, even if the contents of the emails each having an instruction content of correction by the user are exactly the same, the schedule management device 1 can check consistency between the schedule information that the user referred to and the master schedule.

The present invention can also be modified variously and be carried out in other way than having been mentioned above.

That is, in the present invention, it is possible not only to perform the schedule correction processing based on the reply email to the schedule notice email, but also to perform the schedule correction processing with an email based on a transfer email that the other people sent to the schedule management device by quoting the reply email. In this case, in this embodiment, if an email that is a quotation source of the received email cannot be found from the email management unit 3, the processing of the correction email may be put in pending (is interrupted) and the processing may be resumed after the email of the quotation source arrived. Thereby, in the present invention, even if an order of emails by which the emails reach the schedule management device is inverted due to a problem on a delivery path of the emails, it is possible to perform a correct schedule correction processing. On the other hand, in the conventional schedule management device that performs a schedule update processing in the order whereby the emails reach, if the order of arrival of the emails is inverted, there is a risk that the correction that the user does not intend will be performed.

Moreover, in the above-mentioned explanation, although object persons of the schedule were not specified, in the present invention, it is also possible to manage an item as to whose action schedule it is like other items (date, time, place, etc.). By carrying out the present invention in this way, the present invention can be used in order to manage a schedule of a group consisting of a plurality of members. In this case, what is necessary is to configure the contents of the schedule management unit 2 shown in FIG. 5 etc. so that a column called object person may be newly provided in addition to date, time, place, and content, and that a name of an object member or a name of an object group may be stored therein. In the present invention, by managing the object persons, it is easy to conduct following expansions: at the time of transmission of the schedule notice email, the schedule notice email may be configured so that only schedules in which a member becoming a destination of the email is the object person may be extracted and may be included therein; in the schedule correction by email, an item that can be corrected is limited to a schedule item containing the correction email sender as the object person; etc.

Furthermore, in the present invention, as another modification, for example, if a schedule correction content transmitted by email and the master schedule are not consistent with each other, the schedule correction can be performed not only by replying that the update cannot be done simply because of inconsistency but also by transmitting the latest master schedule simultaneously and allowing the schedule to be corrected again using the master schedule as a base. When it is executed in this way, since the user can create the correction email by referring to the latest master schedule, the next correction email has a very high possibility that the correction is consistent with the master schedule and is registered. That is, by performing in this way, even if the schedule correction on the email basis failed, in the present invention, it becomes possible to succeed in the schedule correction with a high probability by retrying it only once.

Furthermore, in the present invention, if the schedule correction content transmitted by email and the master schedule are not consistent with each other, the processing may be realized so that the latest master schedule and the difference information that was not consistent may be both included in a reply to the user from the system. In this way, it is possible to show a point that the user should note in the re-correction.

In this case, a portion that was not consistent may be displayed in bold letters or italics, or may be displayed using a symbol * or the like intelligibly.

Furthermore, although regarding a relationship of the reply and the reply source among emails, the example was explained by assuming that it is stored in the references in the header, in addition to this, the present invention can use various techniques in order to identify the relationship of the reply source (the transfer source) of an email and the reply (mail transmission based on transfer). For example, it is often the case that when doing a reply (mail transmission based on transfer), almost the whole portion of the email of the reply source (the transfer source) is quoted in the end of the email. In this case, since the email of the quotation source can be identified with a relatively high accuracy by establishing matching of a sentence or a character string appeared in a quotation portion, the present invention can be modified in a form that uses a technique of identifying the email of the reply source (the transfer source) by establishing matching of a sentence and a character string appeared in a quotation portion.

Furthermore, it is possible to apply the present invention also to various managements other than the management of a schedule. For example, as a management system for reserving facilities of rooms, equipment, etc., it is possible to realize reference, registration, and correction functions by email with exactly the same method. Especially, it is possible to simply and unerringly perform correction of reservation on the email basis. Generally, it is possible to apply the idea of the present invention to systems each having a database in general. The present invention is extensively applicable to a case where the contents of the database can be written out as a text file, such as a ToDo list that lists what should be done, in addition to the schedule management and facility reservation. For example, an email transmitted from the system with its content in a text form is revised and corrected, if needed, and is sent back to the system. The system compares the received email and the text of the sent email giving rise to the reply source, and extracts a difference. It judges this difference to be the correction content that the user intends, and updates the database if possible. The present invention can apply extensively to any application that follows the above scheme.

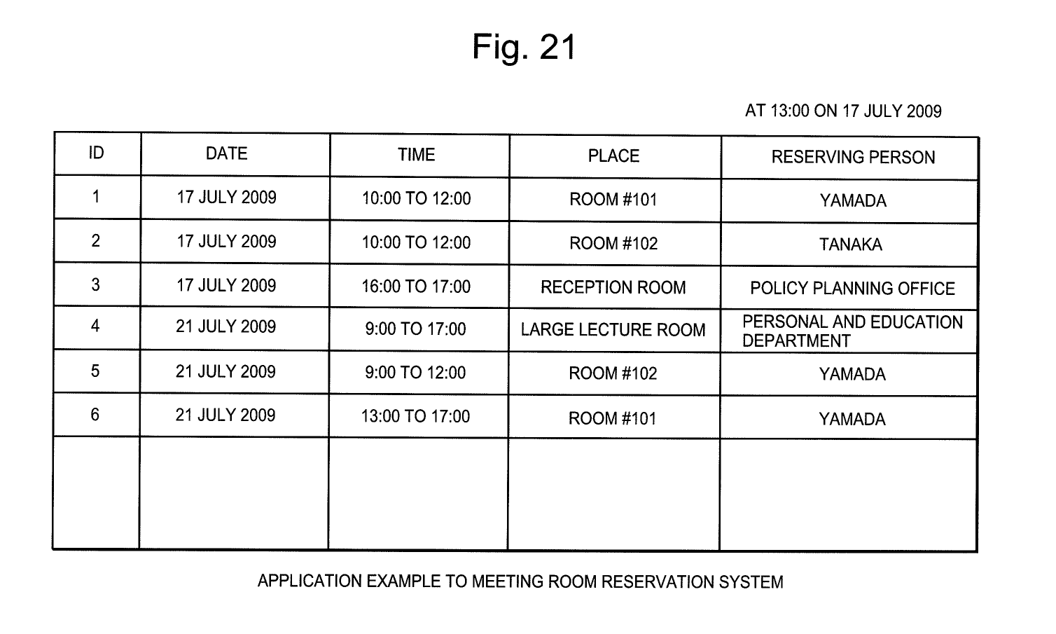

FIG. 21 is a diagram showing one example of the content of the schedule management unit 2 when applying the present invention to a meeting room reservation system. The meeting room reservation system to which the present invention is applied has a configuration of FIG. 1, and reservation dates, reservation times, and reserving persons of each meeting room are stored in the schedule management unit 2. A reservation content notice email in which this content is described in the text body in the form of one-item in one-line is transmitted to the user by the email creation unit 4 every day at a regular time. When the user wishes to alter a reservation content, the user corrects a description content of the received reservation content notice email and transmits the correction email, and consequently, similarly with the case of schedule reservation, a difference extraction result is extracted by the difference extraction unit 6, and the difference is reflected in the schedule management unit by the registration unit 5, whereby the reservation is corrected. Although as a characteristic of meeting room reservation, checking at the time of the registration and at the time of the reservation correction is strengthened, such as imposing a check so that the same meeting room may not be reserved in a duplicated manner, there are especially no alterations in other operations. In this way, by modifying and using the present invention as a meeting room reservation system, it is possible to execute simple and exact reservation alteration by transmission and reception of emails.

What is claimed is:

1. A system comprising:
a management unit configured to store and manage predetermined management information;
an email unit configured to store and manage notice emails that describe at least a part of the management information stored in the management unit;
a transmitter and receiver unit configured to transmit the notice email with the management information to a user terminal and receive a correction email that describes correction management information to the management information described in the transmitted notice email;
an email search unit configured to search the transmitted notice email corresponding to the correction email from the email unit;
a difference extraction unit configured to extract a difference between the correction management information described in the correction email and the management information described in the transmitted notice email; and
a correction unit configured to correct the corresponding management information of the management unit according to the difference extraction result of the difference extraction unit.

2. The system according to claim 1,
wherein, the correction unit is further configured to correct the corresponding management information when the difference extraction result of the difference extraction unit is consistent with the corresponding management information of the management unit.

3. The system according to claim 1,
wherein the difference extraction unit and the correction unit are configured to be responsive to the management information which is at least one of schedule information, a meeting room reservation bulletin, or a ToDo list that describes what to do.

4. The system according to claim 1,
wherein the correction unit is configured to be responsive to the correction email that is either a reply email to the notice email or an email that quotes the reply email, and
wherein the email search unit is configured to search the notice email according to an identification information of the notice email described in either the reply email to the notice email or the email that quotes the reply email.

5. The system according to claim 2,
wherein when the difference extraction result of the difference extraction unit is not consistent with the corresponding management information of the management unit, the email unit is configured to create a return email notifying that the management information described in the notice email and the corresponding management information are not consistent with each other, and
wherein the transmitter and receiver unit is configured to transmit the return email to the user terminal.

6. The system according to claim 5,
wherein the email unit is configured to create the return email that describes the latest management information stored in the management unit.

7. A method for controlling a system, comprising:
storing and managing notice emails that describe at least a part of predetermined management information;
transmitting the notice email with the management information to a user terminal and receiving a correction email that describes correction management information to the management information described in the transmitted notice email;
searching the transmitted notice email corresponding to the received correction email;
extracting a difference between the correction management information described in the correction email and the management information described in the transmitted notice email; and
correcting the corresponding management information according to the difference extraction result.

8. The method according to claim 7, further comprising:
correcting the corresponding management information when the difference extraction result is consistent with the corresponding management information.

9. The method according to claim 7,
wherein the extracting and the correcting are responsive to the management information which is at least one of schedule information, a meeting room reservation bulletin, or a ToDo list that describes what to do.

10. The method according to claim 7,
wherein the correction email is either a reply email to the notice email or an email that quotes the reply email, and
wherein the notice email is searched according to an identification information of the notice email described in either the reply email to the notice email or the email that quotes the reply email in the searching step.

11. The method according to claim 8,
wherein when the difference extraction result is not consistent with the corresponding management information, a return email is created and transmitted to the user terminal, and
wherein the return email is a email notifying that the management information described in the notice email and the corresponding management information are not consistent with each other.

12. The method according to claim 11,
wherein the return email describes the latest management information.

13. A computer readable medium recording thereon a program for enabling a computer to carry out the following:
storing and managing notice emails that describe at least a part of predetermined management information;
transmitting the notice email with the management information to a user terminal and receiving a correction email that describes correction management information to the management information described in the transmitted notice email;
searching the transmitted notice email corresponding to the received correction email;
extracting a difference between the correction management information described in the correction email and the management information described in the transmitted notice email; and
correcting the corresponding management information according to the difference extraction result.

14. The computer readable medium recording thereon a program according to claim 13, the program further including instruction for causing:
correcting the corresponding management information when the difference extraction result is consistent with the corresponding management information .

15. The computer readable medium recording thereon a program according to claim 13,
wherein the extracting and the correcting are responsive to the management information which is at least one of schedule information, a meeting room reservation bulletin, or a ToDo list that describes what to do.

16. The computer readable medium recording thereon a program according to claim 13,
wherein the correction email is either a reply email to the notice email or an email that quotes the reply email, and
wherein the notice email is searched according to an identification information of the notice email described in either the reply email to the notice email or the email that quotes the reply email in the searching step.

17. The computer readable medium recording thereon a program according to claim 14,
wherein when the difference extraction result is not consistent with the corresponding management information, a return email is created and transmitted to the user terminal, and
wherein the return email is an email notifying that the management information described in the notice email and the corresponding management information are not consistent with each other.

18. The computer readable medium recording thereon a program according to claim 17,
wherein the return email describes the latest management information.

19. A system comprising:
a management means for storing and managing predetermined management information;
an email means for storing and managing notice emails that describe at least a part of the management information stored in the management means;
a transmitter and receiver means for transmitting the notice email with the management information to a user terminal and receiving a correction email that describes correction management information to the management information described in the transmitted notice email;
an email search means for searching the transmitted notice email corresponding to the correction email from the email unit;
a difference extraction means for extracting a difference between the correction management information described in the correction email and the management information described in the transmitted notice email; and
a correction means for correcting the corresponding management information of the management means according to the difference extraction result of the difference extraction means.

20. The system according to claim 19, wherein the correction means further comprising:
means for correcting the corresponding management information when the difference extraction result of the difference extraction means is consistent with the corresponding management information of the management means.

21. The system according to claim 20,
wherein the difference extraction means and the correction means are configured to be responsive to the management information which is at least one of schedule information, a meeting room reservation bulletin, or a ToDo list that describes what to do.

22. The system according to claim 20,
wherein the correction means is configured to be responsive to the correction email that is either a reply email to the notice email or an email that quotes the reply email, and
wherein the email search means is configured to search the notice email according to an identification information of the notice email described in either the reply email to the notice email or the email that quotes the reply email.

23. The system according to claim 21,
wherein, the email means is configured to create a return email notifying that the management information described in the notice email and the corresponding management information are not consistent with each other when the difference extraction result of the difference extraction means is not consistent with the corresponding management information of the management means, and
wherein the transmitter and receiver means is configured to transmit the return email to the user terminal.

24. The system according to claim 23,
wherein the email means is configured to be responsive to the return email that describes the latest management information stored in the management means.
